(19) United States
(12) Patent Application Publication
(10) Pub. No.: US 2012/0067276 A1
(43) Pub. Date: Mar. 22, 2012

(54) EQUIPMENT TO DEPOSIT A FLUID SUBSTANCE ON BAKED GOODS

(75) Inventor: Joerg SCHUMANN, Lich (DE)

(73) Assignee: NBS Neue Backtechnik Schumann, Heuchelheim (DE)

(21) Appl. No.: 13/234,219

(22) Filed: Sep. 16, 2011

(30) Foreign Application Priority Data
Sep. 22, 2010 (DE) 10 2010 037 713.9

(51) Int. Cl. B05C 5/00; B05C 11/11; B05C 13/00; B05C 11/00

(52) U.S. Cl. 118/17; 118/13

(57) ABSTRACT

Equipment for depositing a fluid deposition substance onto baked goods, comprises a reservoir for the fluid deposition substance. a deposition unit to deposit the fluid deposition substance onto the baked goods, a feed means to feed the fluid deposition substance from the reservoir into the deposition unit, a conveyor configured underneath the depositing unit to convey the baked goods relative to the deposition unit along one direction of conveyance, a collecting unit situated underneath the conveyor to collect excess deposition substance that was not received on the baked goods, and a temperature controller allowing to temperature-control the equipment at least in segments. The conveyor is fitted with substantially bar-shaped baked-goods support elements which are configured mutually spaced apart in the direction of conveyance (R1) and in a direction (R2) transverse to the direction (R1).

The present invention relates to equipment for depositing a flowable (hereafter “fluid”) substance on baked goods as defined in the preamble of claim 1.

Conventionally, to render baked goods shiny, or brush them with strained apricot jam or icing them, for instance using jelly, icing, jam or chocolate, usually the substance to be deposited is solid or viscous at room temperature and therefore is heated to a higher temperature, and when fit for deposition, is manually applied onto the baked goods. Said substances must be regularly heated or kept at constant temperature and always be stirred again to assure fluid application and to preclude premature solidification, as a result of which such deposition must be interrupted continually. Such a procedure is exceedingly time-consuming and laborious.

A number of ways to rationalize the above procedure already have been proposed in the state of the art. Illustratively the German patent document DE 295 12 601 U1 discloses apparatus to ice/frost baked goods and comprising a reservoir, a feed pump and a depositing element connected to a feed hose. Said reservoir, feed pump and feed hose may be uniformly heated to a constant temperature. The icing to be processed is at the same temperature in the depositing element as in the reservoir. This feature prevents premature cooling of the icing.

Such icing apparatus is economical and therefore also useful to small enterprises. However it incurs the drawback that the substances to be applied still must be deposited manually.

On the other hand, the German patent document DE 199 20 071 B4 describes apparatus automatically coating baked goods with a fluid coating substance. This coating substance is fed through conduits into a misting box from which the substance exits in free fall and impinges the goods below. This apparatus comprises an endless conveyor belt to receive and move the goods, further an evacuating sheetmetal configured underneath said conveyor belt to collect excess coating substance, and a driven unit reinforcing the recycling of the coating substance on the evacuating sheetmetal. Said driven unit comprises a number of sheetmetal scrapers making no contact with the evacuating sheetmetal while acting on the substance which is made to move in this manner. The substance being returned by means of the evacuating sheetmetal makes it possible to recycle it.

This apparatus incurs the drawback of being of complex design. Illustratively it requires a separate drive for the sheetmetal scrapers. As a result manufacture and maintenance are costly.

When coating the goods, the excess coating substance directly impinges the conveyor belt. From there the substance finally reaches other components such as the conveyor rollers. The entire apparatus is soiled as a result. Also waste products or the like may accumulate as a result in various zones of the apparatus, interfering with operation, and, depending on the affected component, possibly entailing corrosion. Accordingly, at the end of operations, the apparatus must be cleansed in highly elaborate and hence costly manner.

Again, the said substance is spread over a large area and, due to cooling or drying, it may solidity after some time. Solidified substance zones then may be processed, if at all, only with great difficulty and labor for further use. Moreover there is danger in the event of incomplete reprocessing that there shall be clumping. To preclude such an eventuality, typically the solidified parts of said substance are discarded prior to overall substance recycling, i.e., they are precluded from the beginning from being reprocessed. Consequently a considerably amount of deposition substance will be lost.

Another considerable drawback encountered in practice is that the baked goods when being moved will only loosely rest on the conveyor belt and thus are susceptible to slip or spin. This applies particularly to baked goods with an uneven resting surface. To assure completely coating the baked coats with the deposition substance, the substance mist must cover the full width of the conveyor belt, and consequently such apparatus entails applying a large excess of deposition substance.

Also, baked goods slipping or rotating when being conveyed will prevent depositing the substance in a defined pattern. As a result the freedom of design is substantially restricted when coating the baked goods, another drawback being incurred.

It is the objective of the present invention to overcome the above and further drawbacks of the state of the art and to create equipment depositing in automated manner a fluid deposition substance on baked goods, said equipment minimizing the quantity of required deposition substance and additionally allowing depositing the substance in a defined pattern. Moreover, the equipment may be built using simple means and allowing simple cleaning.

The main features of the invention are defined in claim 1. Embodiment modes of the invention are defined in claims 2 through 15.

As regards equipment depositing a fluid substance onto baked goods and comprising the following: a reservoir holding the fluid substance, further a deposition unit to deposit the fluid substance onto the baked goods, a feed system to feed the fluid substance from the reservoir into the deposition unit, a conveyor situated underneath the deposition unit to move the baked goods relative to the deposition unit in a given direction of conveyance, a collecting unit situated underneath the conveyor to collect excess substance not applied to the baked goods, and a temperature control keeping the equipment at a constant temperature at least in part(s), the invention provides that the conveyor comprises substantially bar-shaped support elements for the baked goods, where said support elements are mutually spaced in the direction of conveyance and in a direction orthogonal thereto.

The mutually spaced support elements constitute an economical and sturdy means allowing the baked goods to be moved in fixed position relative to the conveyor belt. Said baked goods in this design rest only spot-wise on the ends of the support elements and accordingly may no longer be displaced relative to each other and to the direction of motion. This feature applies in particular to baked goods with uneven or spherical rest surfaces. Even such surfaces are always kept reliably in fixed relative position by the support elements while being moved through the equipment because they always assure a multiple rest for said goods. The baked goods therefore can be moved through the equipment free of any sliding or spinning.

Gaps subtended by the bar-shaped geometry of the support elements and their mutual spacings allow unhampered draining of almost all the excess deposition substance. Accordingly the said excess goods can be almost entirely be used again. Also hardly any depositing substance besides that received by the baked goods may reach the feed system which now is only minimally soiled. The subsequent cleaning procedures are minimized.

Advantageously again, the support elements may be matched with respect to their spacings and shape to the shape, size and weight of the most diverse baked goods.

Thanks to the support elements' mutually fixed positions, the baked goods may be configured on the conveyor using simple implementing means. This feature allows meeting an important pre-condition when depositing one or more substances in a concrete pattern, whereby the equipment of the invention may be used for a plurality of different baked goods fitted with the most diverse decorations or toppings.

Advantageously furthermore, due to the design of the support elements of the invention, the contact area with the baked goods is exceedingly small. As a result the support elements now are unable to transfer any deposition substance to the bake goods' lower sides. Such a problem is eliminated per se, such an advantage being significant in that baked goods showing a soiled lower side are unsightly and therefore will most likely remain unsold. Therefore the design of the support elements of the invention is also unusually advantageous regarding sightliness and economy.

Because the deposited substance no longer reaches the baked goods' rest surfaces and thereby no longer drips off, the equipment of the present invention makes it possible to process several such deposition substances simultaneously and in problem-free manner. Accordingly these deposition substances are effectively prevented from mixing with each other especially as would be caused by dripping from the baked goods or the support elements above a zone of the collecting unit where said zone is used to recycle a second deposition substance. In this instance too good sightliness of the baked goods is preserved.

Because the bar-shaped support elements are narrow and thus pick up hardly any deposition substance, clumping caused by the solidification of adhering substance also is extensively precluded. Therefore the design of the support elements of the invention makes sure that the excess deposition substance is directly guided to the collecting unit and accordingly is made available for further use almost in loss-free manner.

In one significant embodiment mode of the invention, the support elements are arrayed at mutual spacings between them in the direction conveyance, said spacing being less than the baking goods' diameter. As regards non-circular baking goods, their “diameter” is construed being that of an imaginary circle around them. This configuration allows simultaneously depositing a baked good by two spots on it on two support elements adjacent in the direction of conveyance.

Preferably the support elements are configured in the second direction to subtend between them a space smaller than the baked good diameter. This feature meets a significant condition that the baked goods when being conveyed can be configured between two or more support elements and spaced apart in the second direction and in the process can be restrained laterally by said support elements. This design achieves that in particularly baked goods with an uneven rest surface can be restrained in very reliable manner on the support elements.

In the event the support elements are mutually spaced apart both in the direction of conveyance and in the second direction, where said spacing is less than the baked good' diameter, an important requirement can be met, namely to rest the baked goods by three or four points, illustratively at three or four support elements. This feature is especially advantageous by allowing for instance configuring point rest surfaces at the support elements assuming a triangular or tetragonal array.

In a further important embodiment mode of the invention, two support elements are configured pair-wise oppose each other in the direction of conveyance and/or in the second direction. Such support element configuration makes possible a design of at least one support element situated at each opposite side of the baked good. This feature allows holding the baked goods in place very effectively and at minimal cost.

In a further embodiment mode of the invention, the support elements are mounted to or on a conveyor belt. Such a design is especially advantageous because a conveyor belt is an especially economical means to move the baked goods. Furthermore such a design allows spatially separating the conveyor belt acting as the conveying means from the baked goods situated on the support elements. Accordingly and in especially advantageous manner, neither the conveyor belt nor another functionally relevant conveyor zone shall be soiled by the deposition substance when this substance is deposited on the baked goods. Consequently, high operational reliability is attained because interference from corrosion or undesired accumulation of deposition substance/materials are effectively precluded.

In one significant embodiment mode of the invention, two conveyor belts are used and run in the second direction while mutually apart. This features allows making available support elements being mounted to two mutually separate and opposite conveyor belts to receive and hold in place the baked goods. This support element configurations makes possible conveying the baked goods in especially stable manner.

The conveyor belt is designed as a toothed belt in order to preclude it from slipping. The cross-sectional contour of such a belt illustratively may be U- or zig-zag shaped. Such a design meets an important requirement for moving the baked goods remaining in a reliably fixed in position relative to said belt, especially when the support elements are mounted to several conveyor belts. In that case it is critical in order to attain an irrotational motion of the baked goods that the conveyor belts run in slip-free and synchronized manner.

A further important embodiment mode provides that the support elements be arrayed in the second direction in a manner that their free ends project beyond the conveyor belt. Such a configuration of the support elements advantageously allows spacing those support elements—that at least partly make contact with the deposition substance—from the conveyor belts. This design is advantageous for instance in enhancing operational reliability and regarding cleansing costs at the end of operation, any deposition substance at all being precluded from directly reaching the conveyor belt. Preferably too, the support elements shall be configured transversely to the direction of conveyance. As a result comparatively short support elements can be used.

Manufacturing is made easier if each support element is detachably affixed by a retaining means on the conveyor belt. Such a feature is especially advantageous because the conveyor can be matched with minimal effort to the size and shape of diverse baked goods for instance by removing/adding a few support elements. Moreover, where required, support elements illustratively of different lengths and shapes may be used. Again, the said support elements may be quickly and conveniently exchanged as needed.

In a further embodiment mode of the invention, the support elements are supported in the retaining means to allow rotation. This feature as well contributes to moving the baked goods reliably and secured in place.

Again, preferably the conveyor comprises a cleaning means to cleanse the support elements. Said cleaning means reliably precludes accumulations of deposition substance at the support elements, even over extended periods of operation, that might lead to clumping—or, in the case of several such deposition substances, mixing them. Depending on the design of the cleaning means, the rotatable support of the support elements in the retaining means may facilitate completely cleansing the support elements.

A cleaning means cleansing the support elements at regular time intervals during regular operation is especially advantageous. As regards a conveyor using a belt, illustratively configuring the cleaning means in the zone of the belt reversal is especially preferred. The support elements do not carry baked goods in that zone, and accordingly the cleansing of the support elements does not entail interrupting moving the baked goods respectively (hereafter resp.) the equipment operation.

Another embodiment mode of the invention reliably prevents depositing any substance on the conveyor belt by configuring a first hood above each belt.

In yet another embodiment mode of the equipment of the invention, the depositing unit comprises a receptacle fitted with an overflow edge. This geometry is an especially simple and economical way making possible uniform and two-dimensional deposition of the substance onto the baked goods.

Accordingly a further embodiment mode stipulates that the deposition unit comprises at least two receptacles each having an overflow edge. Such an embodiment mode is especially useful because creating equipment allowing depositing at least two different deposition substances. Preferably again, the minimum of at least two receptacles shall stagger each other in the conveying direction R1. As a result, the deposition substances may be applied one after the other onto the baked goods. This geometry is especially advantageous for instance when the first deposition substance is desired, or must begin, to dry before depositing the second deposition substance.

In another important embodiment mode of the invention, the deposition unit is fitted with a feed intake that comprises at least one discharge aperture at a side away from the overflow edge. The configuration of the discharge aperture allows generating a flow profile in the deposition unit in turn entailing defoaming of the deposited substance. Very advantageously, the feed intake is to be configured in a way that the discharge aperture is situated below the typical level of the deposition substance. Besides the advantageous flow cross-section thereby produced in the deposition unit vessel, this feature prevents air from being introduced into the said substance due to swirls into said substance at the intake site. Accordingly the substance is always deposited on the baked goods in bubble-free manner, said goods thereby having a perfect appearance.

In a further embodiment of the invention, a further hood is provided below the overflow edge of the deposition unit. Said deposition unit makes a means available to deposit the substances at different widths. In a preferred design, different positions may be selected for the configuration of said hood orthogonally to the direction of conveyance and hence parallel to the transverse direction. Such a design allows rapidly and simply matching the width of the mist of deposition substance. The hood below the deposition unit illustratively may be a tub-like recess receiving the deposition substance, said tub being locked in different position by means of a rail.

An angled sheetmetal, deposited on the overflow edge of the deposition unit, of either a defined width and/or assuming a given position relative to said edge, is a different and especially economic means to change the width of the mist of deposited substance.

In a further embodiment mode of the invention, the hoods of the equipment together constitute a guide. Besides changing the width of the deposition substance mist, said guide serves to drain excess deposition substance as rapidly and completely as possible and in controlled manner. This guide's controlled draining action contributes to interference-free operation, because, in this manner, the equipment components relating to operation are especially well protected from being soiled by said deposition substance.

Regarding equipment using several fluid deposition substances to be coated on baked goods, said guide may be used furthermore to preclude accidentally mixing the deposition substances.

Also, an especially preferred embodiment mode of the invention stipulates coating the hoods. Rapidly draining the deposition substance illustratively may be attained using low-friction hood coating materials. Appropriate materials to attain substance-repellant coatings for instance are silicone or polytetrafluoroethylene. Using silicone for its thermal insulation properties is especially advantageous when the equipment of the invention is operated at a temperature different from room temperature.

When the equipment of the invention is used for comparatively heavy baked goods, it may be advantageous to fit the conveyor with a mechanical guidance web precluding excessively flexing or tipping the conveyor belt. It may be appropriate in that respect that the conveyor belt be mounted in a mechanical guidance web. Said web illustratively my be U-shaped.

In a further embodiment mode of the invention, the deposition unit comprises a hollow part with at least one discharge aperture. This design is especially simple and economical to make. By means of conduits, the hollow part may be integrated directly in the deposited substance's circulation. This feature may be advantageous when such a deposition substance does not tend to foam or when such a substance may be deposited only within a narrow temperature range. The direct connection makes possible a short substance dwell time in the deposition unit and therefore the complexity and costs of keeping the equipment of the invention at a given temperature may be reduced.

Furthermore the hollow part is configured transversely to the direction of conveyance. In this way the deposition substance can deposited uniformly and flatly. If several discharge apertures are provided, the said substance may be deposited as a strip pattern.

In the light of the above, a further embodiment of the invention provides a limiting element which is supported displaceably in said hollow part and can be fixed in place at different positions. The limiting element is an especially simple means to change the width of the deposition substance mist. In a preferred design, the hollow part is tubular in the region of the discharge apertures. In that case one or two adjustable plungers may be used as limiting elements. This configuration offers the advantage of being able to adjust the deposition substance mist's width in especially economical manner using a sturdy implement.

In another advantageous embodiment mode of the invention, the collecting unit comprises at least one tub-like recess. The tub is used to collect the deposition substance for further uses. By configuring the recess in a sink, the draining of the deposited material can be accelerated.

A collecting unit comprising several sinks is especially advantageous when using the equipment of the invention to deposit several different deposition substances because a reliably separated region is available for each substance to recycle the excess substances. Advantageously in this respect, a suitable separating element is provided to separate from each other the zones containing the sinks. In an especially simple and economical design, said separating elements are in the form of sheetmetals. Illustratively one may use a rectangular sheetmetal which is affixed by a lateral edge to the collecting unit, and of which the upper lateral edge is situated underneath the support elements. Such a sheetmetal allows effectively sub-dividing the region between the conveyor and the collecting unit along the conveying direction, as a result of which different deposited substances can be applied consecutively. This design is especially appropriate for making black-white frosted cookies.

In case the equipment of the invention is being used to deposit several deposition substances, then each substance shall be appropriately serviced by its own pump. In a further embodiment mode of the invention, each deposition substance's pump also may operated in the reverse mode, namely allowing, at the end of operation, to pump any deposition substance remaining in a conduit, back into the reservoir. Also the conveyor conduits may be temperature controlled.

Preferably again, the lower side of said recess is fitted with an extension allowing connecting the collecting unit to a deposition substance receptacle, further with a sieve in said recess or extension. This configuration allows easily interconnecting components for instance by means of conduits. Tubular extension is an especially practical variation. The deposition substance may be moved from the collecting unit to the deposition substance receptacle in the simplest way by gravity. If required, however, a pump may also be used. Detachably affixing the sieve is advantageous to simplify cleansing and maintenance. In this way the sieve may be exchanged as needed, or be cleansed outside the equipment of the invention.

Depending on application, the design of the equipment may include an adjustable spacing between the depositing element and the conveyor. In this manner the equipment may be matched by means of few manual actions to baked goods of different sizes. If the deposition unit is designed to deposit the substance through a mist of substance, then additionally the width of said substance mist can be controlled by the distance between the coating system and the baked good's surface.

Furthermore the conveyor may be connected with one or more conveying means to move the baked goods to/from the support elements. An extended conveying path illustratively may be used to dry the previously deposited substance. Accordingly another embodiment mode makes it possible to drive the feeding operation using the conveyor drive. To that end the feed means may be connected by a common drive shaft to the conveyor. This design allows compactness and reduces equipment costs.

The equipment of the invention comprises a temperature control. This feature is exceedingly advantageous because, the deposition substances used in the region of the baked goods frequently must be heated or cooled. The temperature control preferably regulates the temperature of the deposition substance vessel. Frequently however it is also advantageous to control the temperatures of additional components of said equipment, for instance the conduits and/or the deposition unit and/or the collecting unit. This is especially the case when the deposition substance is very sensitive to temperature fluctuations or when the temperature differential between the desired processing and the ambience is excessive.

A particularly economical temperature control system regulates the temperature by means of a pre-controlled temperature exchange medium such as water. Depending on the kind of deposition substance to be processed, other heat exchange media also may be used, for instance mixtures of water and alcohol. In this manner it is possible to lower the equipment of the invention to temperatures below 0° C. Under some circumstances and when using different deposition substances, it may be appropriate to so design the temperature control system that different temperatures may be selected in given zones.

Further features, details and advantages of the invention are defined by the claims and also follow from the discussions below of illustrative embodiment modes in relation to the appended drawings.

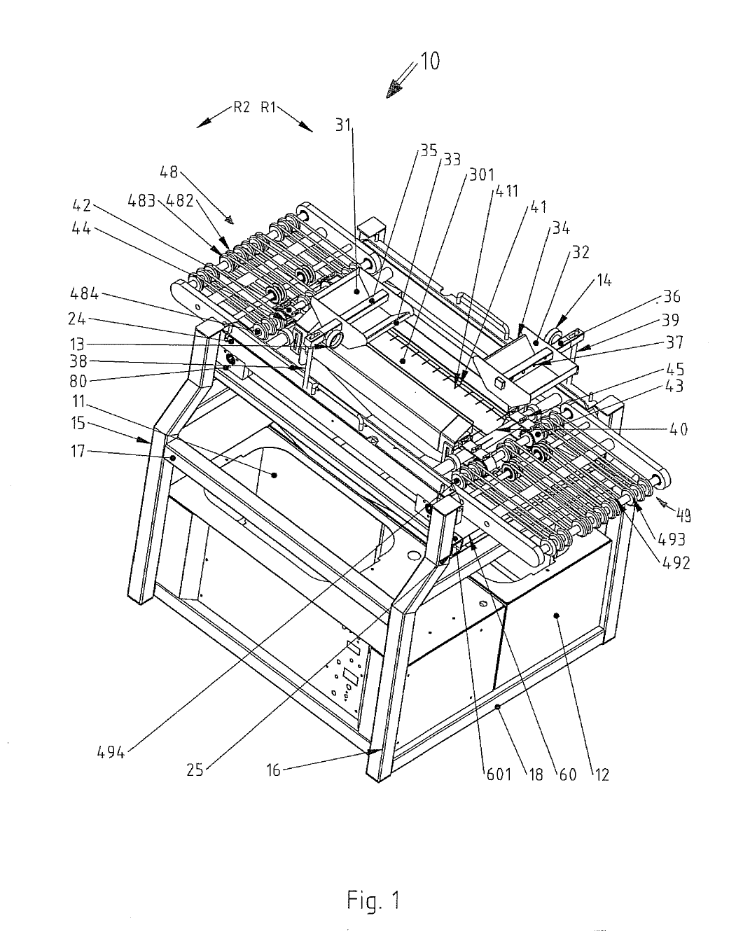

FIG. 1 is a perspective view of the equipment of the invention,

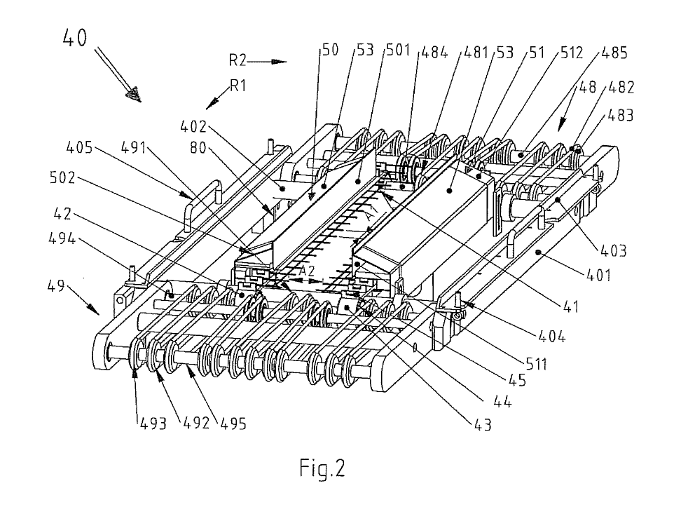

FIG. 2 is a detailed view of a conveyor of equipment of the invention,

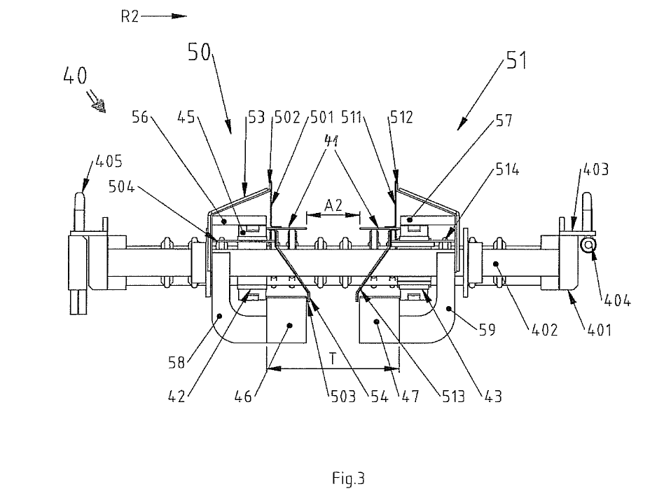

FIG. 3 is a cross-section of the conveyor shown in FIG. 2, and

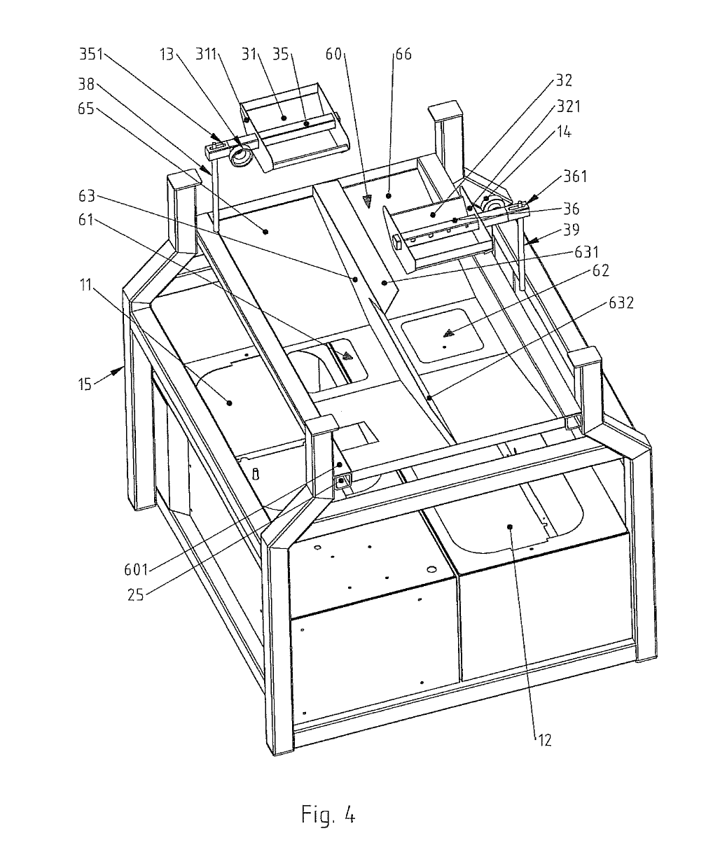

FIG. 4 is a top view of the equipment of the invention with a conveyor,

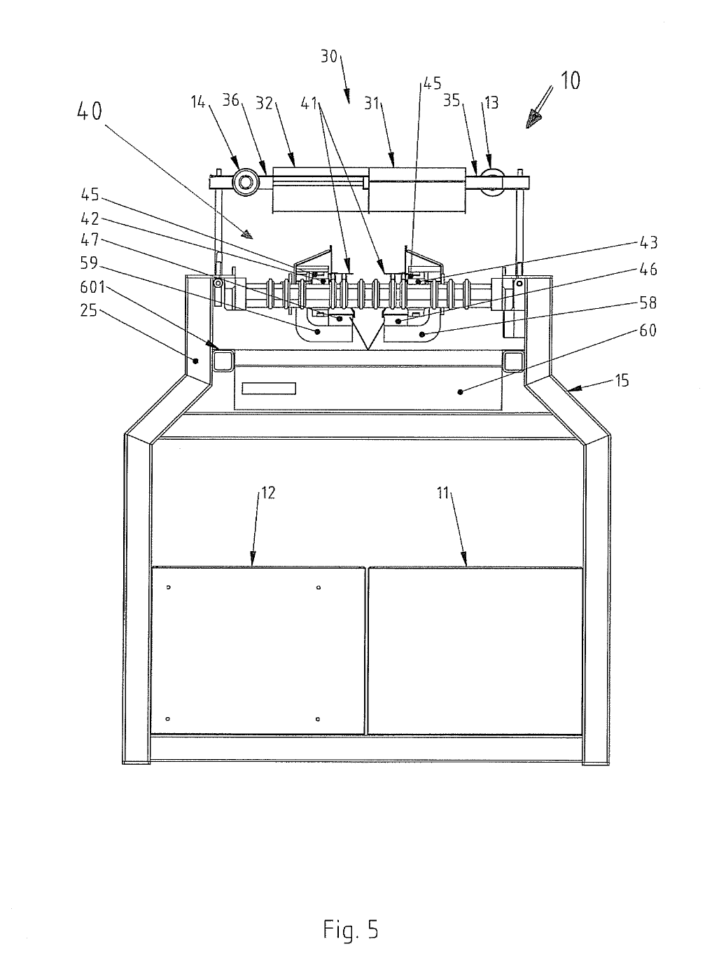

FIG. 5 is a view of the rear side the equipment of the invention shown in FIG. 1.

FIG. 1 is a perspective view of equipment of the invention denoted overall by the reference 10 and depositing fluid deposition substance onto baked goods.

The equipment 10 comprises a frame 15 having four feet 16. The feet 16 are connected to each other by cross-braces 17. A base plate 18 is configured between the feet 16. The said base plate furthermore is affixed to the feet 16 and bears the two reservoirs 11, 12 of the equipment 10. An omitted temperature control of the equipment 10 regulates the temperature of the reservoirs 11, 12 and is situated within these.

A collecting unit 60 is configured above the reservoirs 11, 12. The collecting unit 60 comprises two rest brackets 601 by which it rests on two rails 25 which hold it in place. The rails 25 run parallel to the conveying direction R1 and are affixed to the inside of the frame 15.

A conveyor 40 to move the baked goods along the conveying direction R1 is configured above the collecting unit 60. The conveyor 40 is connected by a rail 24 to the frame 15 and comprises two mutually parallel conveyor belts 42, 43. Retaining elements 45 regularly spaced in the conveying direction R1 are mounted on the conveyor belts 42, 43. Bar-shaped support elements 41 are detachably affixed by means of the retaining elements 45 to the conveyor belts 42, 43, the support elements 41 being rotatably supported in the said retaining elements. The support elements 41 are spaced apart in mutually opposite pairs in the conveying direction R1 and in a direction R2 orthogonal to the direction R1. For simplicity, the direction R2 hereafter also will be denoted the transverse direction R2.

The conveyor 40 is fitted with a drive 80 which may be an electric motor or any other suitable drive means.

The free ends 411 of the support elements 41 project beyond the particular conveyor belt 42, 43 on which they are mounted and each point toward the center of equipment 10. As regards the shown embodiment mode, in each instance two support elements 41 are configured pairwise opposite to each other in the conveying direction R1 and in a second direction R2 transverse to the direction R1. The conveyor belts 42, 43 are toothed belts and in each case are mounted on two gears 44. The gears 44 are connected to drive spindles 484, 494.

In the shown embodiment mode, the conveyor 40 is connected in articulating manner to two feed means 48, 49. The feed means 48, 49 comprise closed bands 482, 492. The bands 482, 492 are configured in two respective guide rollers 483, 493 that are connected at the end of the feed means 48, 49 facing the conveyor 40 to the drive spindles 484, 494. The feed means 48, 49 each can be rotated around their associated drive spindle 484 and 494.

A receptacle 31 of a deposition unit depositing the fluid deposition substances is configured above the conveyor belt 42. The receptacle 31 is connected by a feed intake 35 to a bar or support 38 and is fitted with an overflow edge 33 running parallel to the transverse direction R2. The feed intake 35 is fitted with a hookup 13 allowing connecting said feed intake for instance by means of an omitted hose to the reservoir 11.

A receptacle 32 is situated above the conveyor belt 43. This receptacle 32 is connected by a feed intake 36 to a bar or support 39 and is fitted with an overflow edge 34 running parallel to the transverse direction R2. A hookup 14 is fitted on the feed intake 36 and allows connecting the feed intake 36 by means of an omitted hose or another suitable conduit to the reservoir 12.

The feed intakes 35, 36 are fitted with apertures 37 on their side away the overflow edge 33, 34 of the associated receptacle 31, 32.

The equipment 10 may be used to apply two fluid deposition substances onto baked goods. Initially said baked goods are deposited, for instance manually, on the feed means 48.

The baked goods are moved by the feed means 48 relatively to the deposition unit 30 in the conveying direction R1 by means of the bands 482 to the conveying belts 42, 43 where they are received by the support elements 41 and are conveyed through a deposition range 301 underneath the receptacles 31, 32 of the deposition unit.

While being moved, the baked goods rest on the free ends 411 of the support elements 41 and are held by the latter in this manner. Lastly, at the end of the upper conveyor belts 42, 43, the baked goods are received by the feed means 49 and moved further by the bands 492.

In order to deposit the fluid deposition substances, the temperature-controlled reservoirs 11, 12 are always filled with a fluid deposition substance. By means of an omitted feed element, for instance a hose, these substances are moved from the reservoirs 11, 12 into the intake feed 35, 36 above said reservoirs, entering this feed through its lateral apertures 37 into the associated receptacle 31, 32.

When the maximum capacity of the receptacles 31, 32 is exceeded, said fluid deposition substances move as a mist of deposition substance over the overflow edges 33, 34 of the receptacles into the deposition zone 301. Within the zone 301, the deposition substance mist in free fall then impinges the baked goods being conveyed from the conveyor 40 in the conveying direction R1. The substances are deposited in this manner on the baked goods.

In the present embodiment mode, the receptacles 31, 32 are configured one behind the other in the conveying direction R1 and are offset from each other in the transverse direction R2. Accordingly the two deposition substances are deposited in sequence. By means of this configuration of the receptacles 31, 32 and of the defined and position-stable array of the baked goods on the support elements 41, it is feasible to produce illustratively baked goods in two colors for which the different deposition substances overlap in a relatively small zone. Using the above configuration, the deposition substances can be used efficiently and good appearance can be achieved.

FIG. 2 is a detailed view of a conveyor 40 of the equipment 10 of the invention.

The shown conveyor 40 comprises a support frame. This support frame is constituted by two side supports 401 connected to each other by pipes 402 running parallel to the transverse direction R2. Each side support 401 is fitted with a supporting angle bar 403 allowing connecting, by means of fasteners 404, the conveyor 40 to the equipment of the invention. Grips 405 allowing easy handling of the conveyor 40 are affixed to the angle bar 403.

In the above embodiment mode, the feed means 49 is configured in the front zone of the conveyor 40 and the feed means 48 in its rear zone. Each feed means 48, 49 comprises several bands 492, 482. These bands are resp. guided on two guide rollers 493, 483.

In this embodiment mode, part of the bands 492, 482 is displaced by the drive spindles 494, 484 connected to a drive 80. As a result the spindles 495, 485 are also driven. The residual bands 492, 482 not connected to the drive spindles 494, 484 therefore may be displaced by the indirectly driven spindles 495, 485. This design allows preventing that, in the region in which the gears 44 are mounted on the drive spindles 494, 484, a gap should arise between the adjacent bands 492, 482 that would degrade interference-free displacement of the baked goods when using the conveyor 40.

The conveyor belts 42, 43 are driven by two gears 44. One gear 44 of each conveyor belt 42, 43 is connected to the drive spindle 494 and the other to the drive spindle 484. In this manner, when using the conveyor 40 in equipment of the invention, frictionless transfer of the baked goods between the conveyor 40 and the feed means 49, 48 can take place at the particular transfer sites 491 resp. 481. Advantageously too, this embodiment mode requires no separate drive for the conveyor 40 and the feed means 49, 48.

A hood 50 is configured above the conveyor belt 42 and a hood 51 above the conveyor belt 43. The hoods 50, 51 each comprise a vertically mounted apron 501, 511 connected to an angled sheetmetal 502, 512. The angled sheetmetals 502, 512 comprise an incline, which is situated above the conveyor belts 42, 43 and points toward the lateral supports 401, and which merges at its lower end into a vertical segment. In the shown embodiment mode, the angled sheetmetals 502, 512 moreover are fitted with a material-repellant coating 53.

On account of the design of the hoods 52, 51, the conveyor belts 42, 43 of equipment of the invention can be protected on three sides against undesired substance accumulation. This feature is especially effective. At the same time, due to the inclined angled sheetmetals 502, 512, deposition substances impinging from above may be rapidly evacuated downward.

The conveyor belts 42, 43 configured parallel to each other in the direction of conveyance R1 each comprise several support elements 41 receiving the baked goods during conveyance. These support elements 41 are affixed by retaining elements 45 to the particular conveyor belt 42 resp. 43 and do project beyond said belts.

The bar-shaped support elements 41 are mutually spaced by a distance A1 in the direction of conveyance R1 and a distance A2 in the transverse direction R2. The distances A1 and A2 preferably are less than the diameter of the baked goods being conveyed. This feature is especially advantageous because in such a design the baked goods being conveyed can be held in place by resting point-wise for instance on two adjacent support elements 41 between the conveyor belts 42, 43. Such a rest of the baked goods is highly stable and accordingly especially suitable to move the baked goods in a fixed position relative to the said belts.

FIG. 3 is a cross-section of the conveyor 40 of FIG. 2.

The conveyor 40 comprises a support frame. This support frame is constituted by two lateral rests 401 connected to each other by two pipes 402 running parallel to the transverse direction R2. An angled bar rest 403 is mounted on each lateral rest 401 to allow connecting by means of fasteners 404 the conveyor 40 to the equipment of the invention. Grips 405 are mounted on the angled bar rest 403 to allow conveniently handling the conveyor 40.

FIG. 3 shows that the mutually opposite conveyor belts 42, 43 of the conveyor 40 subtend between them a spacing T. The support elements 41 affixed by fasteners 45 to the particular conveyor belt 42 resp. 43 subtend between them a distance A2 along the transverse direction R2.

The conveyor 42 comprises a hood 50 to protect it against undesired substance accumulation. The conveyor belt 43 comprises a corresponding hood 51.

The hoods 50, 51 each are fitted with an apron 501, 511 connected to an angled sheetmetal 502, 512. Above the conveyor belts 42, 43, the angled sheetmetals 502, 512 exhibit a descending slant in the direction of the lateral rests 401, said slant merging into a vertical portion at the lower end. In the shown embodiment mode, the angled sheetmetals 502, 512 also are fitted with a material-repellant coating 53. The aprons 501, 511 extend slightly beyond the support elements 41 and are fitted at their lower ends with short, horizontal bends which, in equipment of the invention, allow removing deposition substance falling off the conveyor belts 42, 43.

The Figure shows that the hoods 50, 51 of the shown embodiment mode also each comprise a sheetmetal guide 503, 513. The sheetmetal guides 503, 513 are configured closely underneath the support elements 41 and are fitted at the upper end with a horizontal bend. The sheetmetal guides 503, 513 protect the particular conveyor belts 42, 43 both in the upper belt region and in the belt return region against undesired deposition of deposition substance.

The sheetmetal guides 503, 513 each are affixed by means of the sheetmetal guide holder 504 to the associated angled sheetmetal 502, 512 and are also fitted with a material-repellant coating 54.

The vertical bends of the aprons 501,511 project toward the center of the conveyor 40 beyond the vertical bends of the sheetmetal guides 503, 513. When they are used in equipment of the invention, a substance falling from above can be diverted especially effectively from the conveyor belts 42, 43.

In the shown embodiment mode, the conveyor belts 42, 43 run in the upper region—which receives the baked goods—always underneath a guide strip 56, 57 affixed to the pertinent hood 50 resp. 51. These guide strips 56, 57 prevent the conveyor belts 42, 43 from tipping when the baked goods are deposited on their support elements.

One cleaning means 46, 47 is configured everywhere in the region below the conveyor belts 42, 43, that is in the region of the return belts. When operating equipment of the invention, the cleaning means 46, 47 come into contact with the support elements 41 of the conveyor belts 42, 43 which they mechanically cleanse of any adhering deposition substance. Each cleaning means 46, 47 is connected by a fastener 58, 59 to an angled sheetmetal 502, 512.

FIG. 4 is a perspective view of the equipment of FIG. 1 to deposit a fluid deposition substance onto the baked goods without a conveyor.

The equipment comprises a total of two reservoirs 11, 12 from which one of the two fluid deposition substances can be moved by an omitted feed means through the hookups 13 and 14 into the receptacles 31 and 32.

The collecting unit 60 to collect excess deposition substance is situated underneath the receptacles 31 and 32. Through the collecting unit 60, the excess deposition substance moves into the corresponding reservoir 11 resp. 12. The collecting unit 60 comprises two laterally mounted rest brackets 601. These rest brackets 601 each are supported on a rail 25 affixed to the frame 15.

In the shown embodiment mode, the collecting unit 60 comprises two collection zones 65, 66 each fitted with a recess 61 resp. 62 and separated from each other by a partition 63. The collection zones 65, 66 are trough-like. The excess deposition substance passes through the recesses 61 and 62 each situated in a sink of the trough-like collection zones 65 and 66 to reach the reservoirs 11 resp. 12 configured below. Said recesses 61 resp. 62 also may be connected by a hose or a down pipe to the particular reservoirs 11 resp. 12.

The partition 63 is oriented parallel to the direction of conveyance R1 and comprises in its upper zone two slanting bends 631, 632 staggered in the said direction R1. The slants of the two bends 631, 632 run in opposite directions. Each bend 631, 632 points at its lower end in the direction of the particular superposed receptacle 31 resp. 32 and assures—in the case of the equipment with double substance deposition—that the excess substance not absorbed by the baked goods shall be guided in full into the collecting troughs 65 resp. 66 configured underneath the corresponding receptacle 31, 32. The bends 631, 632 therefore represent simple means averting mixing the deposition substances.

The receptacles 31, 32 each comprise two mutually opposite sidewalls 311, 321. These sidewalls 311, 321 are connected to each other approximately centrally by the corresponding feed intakes 35 resp. 36. By means of this design, the receptacles may be made dimensionally more stable on one hand and on the other hand they may be kept above the collecting unit 60 by means of a bar 38, 39 connected to the feed intake 35, 36.

As regards the shown embodiment mode, the bars 38, 39 each may be affixed in an elongated slot 351, 361 subtended in the feed intakes 35, 36. Illustratively a quick-acting tightening means may be used. The configuration of the receptacles 31, 32 may be adjusted in the transverse direction R2 by displacing the said elongated slot 351 relative to the bar 38, 39.

FIG. 5 shows a rear-side view of the equipment 10 of FIG. 1.

The conveyor 40 is situated underneath the deposition unit 30 which comprises two receptacles 31, 32, further the feed intake 35, 36 with the hookups 13, 14. Cleaning means 46, 47 are configured in the region of the conveyor belt return and are each affixed by a fastener 58, 59 to the conveyor 40. In the shown embodiment mode, when operating the conveyor 40, the cleaning means 46, 47 come in contact with the support elements 41 which are connected by retaining elements 45 to the two parallel conveyor belts 42, 43; in this manner simple means allow mechanically cleansing any adhering substance off the support elements 41.

The collecting unit 60 is situated underneath the conveyor 40. FIG. 5 shows that by means of the rest brackets 601 the collecting unit 60 is supported on the rails 25 of the frame 15 and is held in place as a result. The purpose of the collecting unit 60 is to collect excess deposition substance that was not received by the baked goods. A separator is provided to prevent mixing in said collecting unit 60 the two substances deposited by the deposition unit 60 on the baked goods.

The reservoirs 11, 12 are situated underneath the collecting unit 60. The deposition substance received by the collecting unit 60 when the baked goods are being coated arrives by means of the recesses shown in FIG. 4 into the reservoirs 11, 12 underneath.

The present invention is not restricted to the above described embodiment modes, instead it may be widely modified.

All features and advantages discussed above and shown in the appended drawings, including design details, spatial configurations and procedural steps, may be construed being inventive per se as well as in arbitrary combinations.

LIST OF REFERENCES.

| R1 | direction of conveyance |
|---|---|
| R2 | Transverse direction |
| A1 | spacing/distance |
| A2 | spacing/distance |
| T | spacing |
| 10 | equipment |
| 11 | reservoir |
| 12 | reservoir |
| 13 | hookup |
| 14 | hookup |
| 15 | frame |
| 16 | foot |
| 17 | crossbar |
| 18 | bottom plate |
| 24 | rail |
| 25 | rail |
| 30 | déposition unit |
| 301 | déposition range |
| 31 | receptacle |
| 311 | sidewall |
| 32 | receptacle |
| 321 | sidewall |
| 33 | overflow edge |
| 34 | overflow edge |
| 35 | feed intake |
| 351 | elongated slot |
| 36 | feed intake |
| 361 | elongated slot |
| 37 | discharge aperture |
| 38 | bar |
| 39 | bar |
| 40 | conveyor |
| 401 | lateral rest |
| 402 | pipe |
| 403 | angled bar rest |
| 404 | fastener |
| 405 | grip |
| 41 | support element |
| 411 | support element free end |
| 42 | conveyor belt |
| 43 | conveyor belt |
| 44 | gear |
| 45 | retaining element |
| 46 | cleaning means |
| 47 | cleaning means |
| 48 | feed means |
| 481 | Transfer site |
| 482 | band |
| 483 | guide roller |
| 484 | drive spindle |
| 495 | spindle |
| 49 | feed means |
| 491 | transfer means |
| 492 | band |
| 493 | guide roller |
| 494 | drive spindle |
| 495 | spindle |
| 50 | hood |
| 501 | apron |
| 502 | angled sheetmetal |
| 503 | sheetmetal guide |
| 504 | sheetmetal guide holder |
| 51 | hood |
| 511 | apron |
| 512 | angled sheetmetal |
| 513 | sheetmetal guide |
| 514 | sheetmetal guide holder |
| 53 | coating |
| 54 | coating |
| 56 | guide strip |
| 57 | guide strip |
| 58 | fastener |
| 59 | fastener |
| 60 | collection unit |
| 601 | rest bracket |
| 61 | recess |
| 62 | recess |
| 63 | partition |
| 631 | bend |
| 632 | bend |
| 65 | collecting trough |
| 66 | collecting trough |
| 80 | drive |

1. Equipment (10) depositing a fluid deposition substance onto baked goods, comprising
a reservoir (11, 12) for the fluid deposition substance
a deposition unit (30) to deposit the fluid deposition substance onto the baked goods,
a feed means to feed the fluid deposition substance from the reservoir (11, 12) into the deposition unit (30),
a conveyor (40) configured underneath the depositing unit (30) to convey the baked goods relative to the deposition unit (30) along one direction of conveyance (R1),
a collecting unit (60) situated underneath the conveyor (40) to collect excess deposition substance that was not received on the baked goods, and
a temperature controller allowing to temperature-control the equipment (10) at least in segments,
characterized
in that the conveyor (40) is fitted with substantially bar-shaped baked-goods support elements (41) which are configured mutually spaced apart in the direction of conveyance (R1) and in a direction (R2) transverse to the direction (R1).

2. Equipment as claimed in claim 1, characterized in that the support elements (41) are configured at a mutual spacing (A1) in the direction of conveyance (R1), said spacing (R1) being less than the baked goods diameter.

3. Equipment as claimed in claim 1, characterized in that the support elements are configured at a mutual spacing (A2) in the second direction (R2), said spacing (A2) being less than the baked goods diameter.

4. Equipment as claimed in claim 1, characterized in that as regards the direction of conveyance (R1) and/or the second direction (R2), in each case two support elements (41) are configured pairwise and mutually opposite.

5. Equipment as claimed in claim 1 4, characterized in that the support elements (41) are configured at or on a conveyor belt (42, 43).

6. Equipment (10) as claimed in claim 5, characterized by two conveyor belts (42, 43) that are mutually parallel in the second direction (R2) and apart a distance (T).

7. Equipment (10) as claimed in claim 5, characterized in that the conveyer belt (42, 43) is a toothed belt.

8. Equipment (10) as claimed in claim 5, characterized in that the support elements (41) are configured in the second direction (R2) in a manner that they project by their free ends (411) beyond the conveyor belt (42, 43).

9. Equipment (10) as claimed in claim 5, characterized in that each support element (41) is detachable affixed by a retaining element (45) to the conveyor belt (42, 43).

10. Equipment (10) as claimed in claim 9, characterized in that the support elements (41) are rotatably supported in the retaining elements (45).

11. Equipment (10) as claimed in claim 1, characterized in that the conveyor (40) comprises a cleaning means (46, 47) to cleanse the support elements (41).

12. Equipment (10) as claimed in claim 5, characterized in that a first hood (50) is configured above each conveyor belt (42, 43).

13. Equipment (10) as claimed in claim 1, characterized in that the deposition unit (30) comprises a receptacle (31, 32) fitted with an overflow edge (33, 34).

14. Equipment (10) as claimed in claim 13, characterized in that the deposition unit (30) is fitted with a feed intake (35, 36) to move the deposition substance into the receptacle (31, 32), the feed intake (35, 36) comprising at least one discharge aperture (37) at a side away from the overflow edge (33, 34).

15. Equipment (10) as claimed in claim 13, characterized by a further hood (51) being configured underneath the overflow edge (33, 34) of the deposition unit (30).
